(19) United States
(12) Patent Application Publication
(10) Pub. No.: US 2016/0086688 A1
(43) Pub. Date: Mar. 24, 2016

(54) METHOD FOR PRODUCING ELECTRICALLY CONDUCTIVE FILM AND ELECTRICALLY CONDUCTIVE FILM

(71) Applicant: FUJIFILM Corporation, Tokyo (JP)

(72) Inventors: Yushi HONGO, Kanagawa (JP); Misato SASADA, Kanagawa (JP); Yuuichi HAYATA, Kanagawa (JP)

(73) Assignee: FUJIFILM Corporation, Tokyo (JP)

(21) Appl. No.: 14/962,441

(22) Filed: Dec. 8, 2015

Related U.S. Application Data
(63) Continuation of application No. PCT/JP2014/068040, filed on Jul. 7, 2014.

(30) Foreign Application Priority Data
Jul. 10, 2013 (JP) 2013-144811

(51) Int. Cl. H01B 1/22

(52) U.S. Cl. CPC H01B 1/22

(57) ABSTRACT

Provided is a method for producing an electrically conductive film including a coating film forming step of forming a coating film by applying an electrically conductive film forming composition including copper oxide particles, copper particles, and an organic compound having at least one functional group selected from the group consisting of a hydroxy group and an amino group and having a temperature at which a mass reduction rate when the film is heated at a temperature rising rate of 10° C./min is 50% within a range of 120° C. to 350° C. to a resin substrate, and an electrically conductive film forming step of forming an electrically conductive film containing metal copper by performing a heat treatment for heating the coating film to a heating temperature of 140° C. to 400° C. at a temperature rising rate of 30° C./min to 10,000° C./min, and an electrically conductive film.

### CROSS-REFERENCE TO RELATED APPLICATIONS

This application is a Continuation of PCT International Application No. PCT/JP2014/068040 filed on Jul. 7, 2014, which claims priority under 35 U.S.C. §119(a) to Japanese Patent Application No. 2013-144811 filed on Jul. 10, 2013. The above application is hereby expressly incorporated by reference, in its entirety, into the present application.

### BACKGROUND OF THE INVENTION

1. Field of the Invention

The present invention relates to a method for producing an electrically conductive film. More specifically, the present invention relates to a method for producing an electrically conductive film using specific heat treatment conditions.

2. Description of the Related Art

As a method for forming a metal film on a resin substrate, a technique is known in which a resin substrate is coated with a dispersion of metal particles or metal oxide particles by a printing method, the coated dispersion is sintered by being subjected to a heat treatment, and thus an electrically conductive site such as a metal film or wiring in a circuit board is formed.

Compared to the conventional wiring preparation method that is performed by high temperature vacuum processing (sputtering) or a plating treatment, the aforementioned method is simple and saves energy and resources. Therefore, the method is regarded as a highly promising technique for the development of next-generation electronics.

For example, JP2007-080720A discloses a method for forming a metal circuit by applying an electrically conductive metal paste containing copper oxide ultra-fine particles having an average particle diameter of 200 nm or less, a copper filler having an average particle diameter 0.5 μm to 20 μm, a polyhydric alcohol having 10 or less carbon atoms, and/or a polyether compound on an insulating substrate in a circuit pattern by a dispenser, screen printing, or the like, and performing a heat treatment on the paste to convert the paste into a metal circuit. Also, it is disclosed that the temperature of a sintering furnace is raised from room temperature to 350° C. for 20 minutes, and after the temperature reaches 350° C., the substrate is further subjected to a heat treatment for 1 hour at this temperature.

### SUMMARY OF THE INVENTION

On the other hand, in the recent years, in order to respond to the demand for miniaturization and performance improvement of electronic instruments, wiring in a printed wiring board or the like has been further miniaturized and integrated to a higher degree. In addition, producing an electrically conductive film having excellent adhesiveness and conductivity on a resin substrate along with the versatility of the resin substrate and energy saving of the processing is required.

However, when the present inventors have attempted to produce an electrically conductive film using the electrically conductive film forming composition disclosed in JP2007-080720A, the adhesiveness and conductivity of the obtained electrically conductive film does not reach a level required in these days and a further improvement in adhesiveness and conductivity has been required.

In addition, from the demand of a reduction in production costs of electronic instruments, it is required to improve productivity. However, depending on the production conditions for the electrically conductive film, when the heating temperature is set to a heat resistant temperature of the resin substrate or lower, there arises a problem that warping occurs in the resin substrate.

Therefore in the related art, there has been no technique in which an electrically conductive film having excellent adhesiveness and conductivity can be formed at a low temperature without causing warping in a resin substrate.

The present invention has been made in consideration of the aforementioned circumstances, and an object thereof is to provide a method for producing an electrically conductive film in which an electrically conductive film having excellent adhesiveness and conductivity can be formed at a low temperature without causing warping in a resin substrate.

In addition, another object of the present invention is to provide an electrically conductive film that is produced by using the method for producing an electrically conductive film.

As a result of conducting intensive research to solve the problems of the related art, the present inventors have found a region in which a reducing agent functions effectively and stress to be applied to a resin substrate at the time of forming an electrically conductive film is minimized when conducting research on a temperature rising rate at the time of heating, and based on this finding, the aforementioned problems can be solved.

That is, the present inventors have found that the aforementioned objects can be achieved by the following constitution.

(1) A method for producing an electrically conductive film including:

a coating film forming step of forming a coating film by applying an electrically conductive film forming composition including copper oxide particles, copper particles, and an organic compound having at least one functional group selected from the group consisting of a hydroxy group and an amino group and having a temperature at which a mass reduction rate when the film is heated at a temperature rising rate of 10° C./min is 50% within a range of 120° C. to 350° C., to a resin substrate; and

an electrically conductive film forming step of forming an electrically conductive film containing metal copper by performing a heat treatment for heating the coating film to a heating temperature of 140° C. to 400° C. at a temperature rising rate of 30° C./min to 10,000° C./min.

(2) The method for producing an electrically conductive film according to (1), in which in the electrically conductive film forming step, the temperature rising rate is 150° C./min to 4,000° C./min.

(3) The method for producing an electrically conductive film according to (1), in which in the electrically conductive film forming step, the temperature rising rate is 300° C./min to 1,500° C./min.

(4) The method for producing an electrically conductive film according to any one of (1) to (3), in which in the electrically conductive film forming step, the heating temperature is 200° C. to 350° C.

(5) The method for producing an electrically conductive film according to any one of (1) to (4), in which the resin substrate is formed of polyimide.

(6) The method for producing an electrically conductive film according to any one of (1) to (5), in which the thickness of the resin substrate is 25 μm to 125 μm.

(7) The method for producing an electrically conductive film according to any one of (1) to (6), in which a mass ratio of the copper particles to the copper oxide particles is 100% by mass to 300% by mass.

(8) The method for producing an electrically conductive film according to any one of (1) to (7), in which a mass ratio of the organic compound to the copper oxide particles is 10% by mass to 50% by mass.

(9) The method for producing an electrically conductive film according to any one of (1) to (8), in which an average particle diameter of the copper oxide particles is 20 nm to 50 nm.

(10) The method for producing an electrically conductive film according to any one of (1) to (9), in which an average particle diameter of the copper particles is 0.1 μm to 10 μm.

(11) The method for producing an electrically conductive film according to any one of (1) to (10), in which in the electrically conductive film forming step, the heat treatment is performed in an inert gas atmosphere.

(12) An electrically conductive film that is produced by the method for producing an electrically conductive film according to any one of (1) to (11).

According to the present invention, it is possible to provide a method for producing an electrically conductive film in which an electrically conductive film having excellent adhesiveness and conductivity can be formed at a low temperature without causing warping in the resin substrate.

In addition, according to the present invention, it is also possible to provide an electrically conductive film that is produced by the method for producing an electrically conductive film.

### DESCRIPTION OF THE PREFERRED EMBODIMENTS

Hereinafter, preferable embodiments of the method for producing an electrically conductive film and an electrically conductive film forming composition according to the present invention will be described in detail.

First, characteristics of the present invention compared to the related art will be specifically described.

One of the characteristics of the present invention is that a coating film formed by applying an electrically conductive film forming composition including an organic compound having at least one functional group selected from the group consisting of a hydroxy group and an amino group and having a temperature at which a mass reduction rate when the film is heated at a temperature rising rate of 10° C./min is 50% within a range of 120° C. to 350° C. (hereinafter, also referred to as a “specific organic compound”) to a resin substrate is subjected to a heat treatment for heating the coating film to a heating temperature of 140° C. to 400° C. at a temperature rising rate of 30° C./min to 10,000° C./min. When the heating temperature is within the aforementioned range, reduction of copper oxide by a reducing agent that is generated by decomposing the specific organic compound through heating is promoted and adhesiveness and conductivity are improved. In addition, when the temperature rising rate is within the aforementioned range, warping of the resin substrate can be inhibited. Also, because the reducing agent functions well, reduction of copper oxide is promoted and thus adhesiveness and conductivity are improved.

In the following description, first, various components of the electrically conductive film forming composition (copper oxide particles, copper particles, a specific organic compound, and the like) will be described in detail and then the method for producing the electrically conductive film will be described in detail.

<Copper Oxide Particles>

The electrically conductive film forming composition includes copper oxide particles. Copper oxide of copper oxide particles is reduced to metal copper by a heat treatment and constitutes metal copper in an electrically conductive film together with copper particles which will be described later.

The average particle diameter of the copper oxide particles is not particularly limited and is preferably within a range of 10 nm to 100 nm and more preferably within a range of 20 nm to 50 nm. When the average particle diameter of the copper oxide particles is 10 nm or more, the activity of the particle surface does not become excessively high, and the particles are easily dispersed in the composition. Thus, this case is preferable since the particles exhibit excellent handleability and storage stability. In addition, when the average particle diameter of the copper oxide particles is 100 nm or less, a pattern such as wiring is easily formed by a printing method using the composition as an ink composition for ink jet. Further, when the composition is made into a conductor, the active surface becomes wider and thus particles are easily reduced to metal copper. Thus, this case is preferable since the obtained electrically conductive film exhibits good conductivity.

Here, the “copper oxide” used in the present invention refers to a compound which does not substantially contain copper that is not oxidized. Specifically, the “copper oxide” refers to a compound from which a peak resulting from copper oxide is detected and from which a peak resulting from metal copper is not detected in crystal analysis utilizing X-ray diffraction. The clause “substantially does not contain copper” means a state in which the content of copper is equal to or less than 1% by mass with respect to the total mass of the copper oxide particles.

As the copper oxide, copper (I) oxide or copper (II) oxide is preferable. Of these, copper (II) oxide is more preferable since it is available at a low cost and has excellent stability in the air.

As the copper oxide particles, known copper oxide particles used for an electrically conductive film forming composition can be used. For examples, as the copper oxide particles, CuO nanoparticles manufactured by KANTO KAGAKU, CuO nanoparticles manufactured by Sigma-Aldrich Co. LLC., and the like can be used.

The average particle diameter of the copper oxide particles in the present invention refers to an average primary particle diameter of the copper oxide particles. The average particle diameter of the copper oxide particles is obtained by measuring the particles diameters (diameters) of at least 50 or more copper oxide particles through observation with a transmission electron microscope (TEM) or a scanning electron microscope (SEM) and obtaining the arithmetic mean. When the shape of the copper oxide particles in the observed image is not a perfect circle, the major axis of the particles is measured as the diameter.

<Copper Particles>

The electrically conductive film forming composition includes copper particles. The copper particles constitute metal copper in the electrically conductive film together with metal copper generated from copper oxide of the aforementioned copper oxide particles reduced by a heat treatment at the time of film formation.

The average particle diameter of the copper particles is not particularly limited and is preferably within a range of 0.1 μm to 20 μm, more preferably within a range of 0.1 μm to 10 μm, and still more preferably within a range of 0.2 μm to 5 μm. When the average particle diameter of the copper particles is 0.1 μm or more, this case is preferable since the obtained electrically conductive film exhibits excellent conductivity. In addition, when the average particle diameter of the copper particles is 20 μm or less, fine wiring easily formed and thus this case is preferable.

As the copper particles, known metal copper particles used for an electrically conductive film forming composition can be used. For example, as the copper particles, a wet copper powder 1020Y, a wet copper powder 1030Y, a wet copper powder 1050Y, a wet copper powder 1100Y, and the like, all manufactured by MITSUI MINING & SMELTING CO., LTD., can be used.

The average particle diameter of the copper particles in the present invention refers to an average primary particle diameter of the copper particles. The average particle diameter of the copper particles is obtained by measuring the particle diameters (diameters) of at least 50 or more copper particles through observation with a transmission electron microscope (TEM) or a scanning electron microscope (SEM) and obtaining the arithmetic mean. When the shape of the copper particles in the observed image is not a perfect circle, the major axis of the particles is measured as the diameter.

<Specific Organic Compound>

The electrically conductive film forming composition includes a specific organic compound. The specific organic compound is a latent reducing agent which generates a reducing agent by decomposing the specific organic compound by a heat treatment at the time of film formation. Metal copper that is formed by reducing copper oxide by the generated reducing agent promotes fusion between the copper particles.

As long as the specific organic compound has at least one functional group selected from the group consisting of a hydroxy group and an amino group, and has a temperature at which a mass reduction rate when the film is heated at a temperature rising rate of 10° C./min is 50% (hereinafter, also referred to as a “50% mass reduction temperature”) within a range of 120° C. to 350° C., the specific organic compound is not particularly limited.

In the present invention, the 50% mass reduction temperature of the specific organic compound was obtained as a temperature at which the mass of the sample of specific organic compound to be measured was reduced to 50% while heating the sample of the specific organic compound to be measured (3 mg) at a temperature rising rate of 10° C./min in a nitrogen atmosphere using a thermogravimetric apparatus (TG/DTA6200, manufactured by Hitachi High-Tech Science Corporation), measuring a change in the mass, and recording the mass with respect to the temperature.

As the specific organic compound, saccharides such as monosaccharides, disaccharides, trisaccharides, and sugar alcohols can be used.

Examples of monosaccharides include monosaccharides represented by the formula CₙH₂ₙOₙ or CₘH₂ₘOₘ₋₁. Here, in the formula, m and n are independently selected from natural numbers from 4 to 7. Preferable specific examples of monosaccharides include dihydroxyacetone and glyceraldehyde (all, n=3); erythrulose, erythrose, threose, ribulose, and xylulose (all, n=4); ribulose, xylulose, ribose, arabinose, xylose, lyxose (all, n=5), and deoxyribose (m=5); allose, altrose, glucose, mannose, gulose, idose, galactose, talose, psicose, fructose, sorbose, and tagatose (all, n=6); fucose, fuculose, and rhamnose (all, m=6); and sedoheptulose (n=7).

Examples of disaccharides include disaccharides represented by the formula CₙH₂ₙ₋₂Oₙ₋₁. Here, in the formula, n is a natural number from 8 to 12. Preferable specific examples of disaccharides include sucrose, lactose, maltose, trehalose, turanose, and cellobiose (all, n=12).

Examples of trisaccharides includes trisaccharides represented by the formula CₙH₂ₙ₋₄Oₙ₋₂. Here, in the formula, n is a natural number from 12 to 18. Preferable specific examples of trisaccharides include raffinose, melezitose, and maltotriose (all, n=18).

Examples of sugar alcohols include sugar alcohols represented by the formula CₙH₂ₙ₋₂Oₙ. Here, in the formula, n is a natural number from 3 to 6. Preferable specific examples of sugar alcohols include glycerin (n=3); erythritol, D-threitol, and L-threitol (all, n=4); D-arabinitol, xylitol, and ribitol (all, n=5); and D-iditol, galactitol, sorbitol, and mannitol (all, n=6).

As the specific organic compound, an amine compound can be also used.

The amino group of the amine compound may be a primary, secondary, or tertiary amino group. In the case in which the amine compound has plural amino groups, each amino group may be each independently a primary, secondary, or tertiary amino group.

As such an amine compound, a compound having an amino group and at least one group selected from the group consisting of an amino group and a hydroxy group in a molecule is preferable.

Examples of such an amine compound include a compound represented by Formula (I) below.

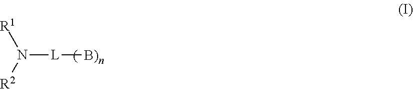

In Formula (I):

R¹ and R² are each independently a substituent selected from the group consisting of a hydrogen atom or an alkyl group, one or more hydrogen atoms of the alkyl group may be optionally substituted with a hydroxy group or an amino group, and one or more —CH₂— groups not adjacent to N of the alkyl group may be optionally substituted with an —O— group or an —NR— group (where R is a hydrogen atom or an alkyl group) under the condition that adjacent —CH₂— groups are not substituted simultaneously with an —O— group or an —NR— group;

L is a linking group having a valence of n+1;

when there are plural Bs, Bs are each independently a hydroxy group or an amino group; and

n is a natural number.

It is preferable that R¹ and R² are each independently a hydrogen atom or an alkyl group having 1 to 3 carbon atoms, and the hydrogen atom of the alkyl group may be optionally substituted with a hydroxy group, a —NH₂ group, a —NHCH₃ group or a —N(CH₃)₂ group.

It is preferable that L is a linking group having a valence of n+1, which is obtained by removing n+1 hydrogen atoms from a linear or branched alkane having in carbon atoms.

Here, m and n are natural numbers satisfying m≧(n−1)/2.

In addition, the —CH₂— group in L may be optionally substituted with an —O— group or an —NR— group (where R is a hydrogen atom or an alkyl group).

Examples of such an amine compound further include a compound represented by Formula (II) below.

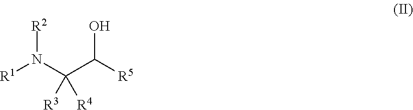

In Formula (II):

R¹ and R² are each independently a substituent selected from the group consisting of a hydrogen atom or an alkyl group, one or more hydrogen atoms of the alkyl group may be optionally substituted with a hydroxy group or an amino group, and one or more —CH₂— groups not adjacent to N of the alkyl group may be optionally substituted with an —O— group or an —NR— group (where R is a hydrogen atom or an alkyl group) under the condition that adjacent —CH₂— groups are not substituted simultaneously with an —O— group or an —NR— group; and

R³, R⁴, and R⁵ are each independently a substituent selected from the group consisting of a hydrogen atom, an alkyl group, a hydroxy group, and an amino group, one or more hydrogen atoms of the alkyl group may be optionally substituted with a hydroxy group or an amino group and one or more —CH₂— groups of the alkyl group may be optionally substituted with an —O— group or an —NR— group (where R is a hydrogen atom or an alkyl group) under the condition that adjacent —CH₂— groups are not substituted simultaneously with an —O— group or an —NR— group.

It is preferable that R¹ and R² are each independently a hydrogen atom or an alkyl group having 1 to 3 carbon atoms, and the hydrogen atom of the alkyl group may be optionally substituted with a hydroxy group, a —NH₂ group, a —NHCH₃ group or a —N(CH₃)₂ group.

It is preferable that R³, R⁴, and R⁵ are each independently a hydrogen atom, an alkyl group having 1 to 3 carbon atoms, a hydroxy group, a —NH₂ group, a —NHCH₃ group or a —N(CH₃)₂ group, and the hydrogen atom of the alkyl group may be optionally substituted with a hydroxy group, a —NH₂ group, a —NHCH₃ group or a —N(CH₃)₂ group.

Specific examples of the amine compound include compounds shown below.

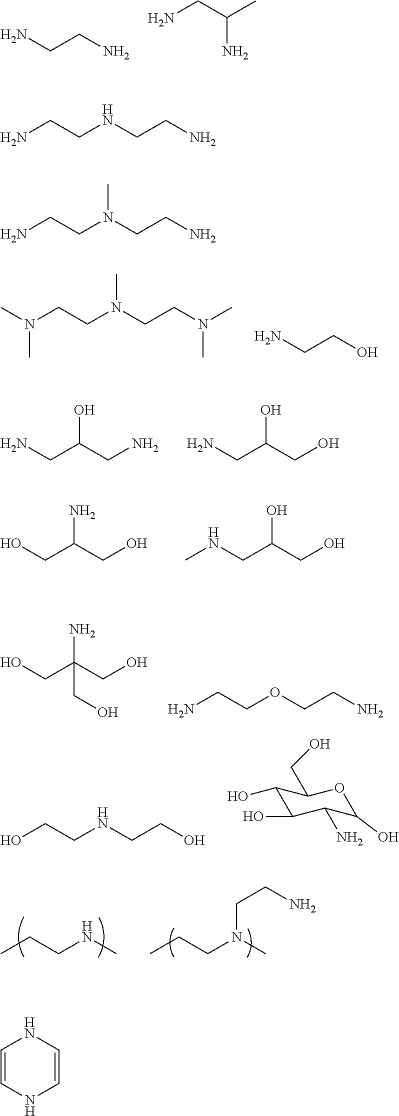

Preferable specific examples of the specific organic compound include glucose (310° C.), sorbitol (350° C.), sucrose (340° C.), and 3-aminopropane-1,2-diol (180° C.). Here, the temperature in the parentheses is a 50% mass reduction temperature.

<Solvent>

The electrically conductive film forming composition may further include a solvent. Examples of the solvent include one solvent selected from water, alcohols, ethers, esters, hydrocarbons, and aromatic hydrocarbons, and two or more solvents having compatibility as a mixture may be used.

As the solvent, from the viewpoint of excellent compatibility with the specific organic compound, water, water-soluble, alcohols, alkyl ethers derived from the water-soluble alcohols, alkyl esters derived from the water-soluble alcohols, or a mixture of these can be preferably used.

As the water, water having a purity at least at a level of ion-exchanged water is preferable.

As the water-soluble alcohols, aliphatic alcohols having monovalent to trivalent hydroxy groups are preferable and specific examples thereof include methanol, ethanol, 1-propanol, 1-butanol, 1-pentanol, 1-hexanol, cyclohexanol, 1-heptanol, 1-octanol, 1-nonanol, 1-decanol, glycidol, methylcyclohexanol, 2-methyl-1-butanol, 3-methyl-2-butanol, 4-methyl-2-pentanol, isopropyl alcohol, 2-ethylbutanol, 2-ethylhexanol, 2-octanol, terpineol, dihydroterpineol, 2-methoxyethanol, 2-ethoxyethanol, 2-n-butoxyethanol, carbitol, ethylcarbitol, n-butylcarbitol, diacetone alcohol, ethylene glycol, diethylene glycol, triethylene glycol, tetraethylene glycol, propylene glycol, trimethylene glycol, dipropylene glycol, tripropylene glycol, 1,2-butylene glycol, 1,3-butylene glycol, 1,4-butylene glycol, pentamethylene glycol, hexylene glycol, and glycerin.

Among these, since the aliphatic alcohols with 1 to 6 carbon atoms, having monovalent to trivalent hydroxy groups, have a boiling point that is not too high and for which remaining after forming an electrically conductive film is difficult, the aliphatic alcohols are preferable. Specifically, methanol, ethylene glycol, glycerin, 2-methoxyethanol, diethylene glycol, and isopropyl alcohol are more preferable.

The ethers may be alkyl ethers derived from the aforementioned alcohols, and examples thereof include diethyl ether, diisobutyl ether, dibutyl ether, methyl-t-butyl ether, methylcyclohexyl ether, diethylene glycol dimethyl ether, diethylene glycol diethyl ether, triethylene glycol dimethyl ether, triethylene glycol diethyl ether, tetrahydrofuran, tetrahydropyran, and 1,4-dioxane. Among these, alkyl ethers with 2 to 8 carbon atoms, derived from the aliphatic alcohols with 1 to 4 carbon atoms, having monovalent to trivalent hydroxy groups, are preferable, and specifically, diethyl ether, diethylene glycol dimethyl ether, and tetrahydrofuran are more preferable.

The esters include alkyl esters derived from the aforementioned alcohols, and examples thereof include methyl formate, ethyl formate, butyl formate, methyl acetate, ethyl acetate, butyl acetate, methyl propionate, ethyl propionate, butyl propionate, and γ-butyrolactone. Among these, alkyl esters with 2 to 8 carbon atoms, derived from aliphatic alcohols with 1 to 4 carbon atoms, having monovalent to trivalent hydroxy groups, are preferable, and specifically, methyl formate, ethyl formate, and methyl acetate are more preferable.

Among these solvents, the solvent having a boiling point which is not too high, particularly water or water-soluble alcohol, is preferably used as a main solvent. The main solvent is a solvent with the highest content among the solvents.

<Other Components>

The electrically conductive film forming composition may include components other than copper oxide particles, copper particles, the specific organic compound, and the solvent.

For example, the electrically conductive film forming composition may include a surfactant, a thixotropic agent, a thermoplastic resin (polymer binder), and the like.

The surfactant has a function of improving dispersibility of the copper oxide particles or the copper particles. The type of the surfactant is not particularly limited and examples thereof include an anionic surfactant, a cationic surfactant, a nonionic surfactant, a fluorosurfactant, and an amphoteric surfactant. These surfactants can be used alone or in combination of two or more thereof.

The thixotropic agent imparts thixotropy to the electrically conductive film forming composition and prevents dripping of the electrically conductive film forming composition before the electrically conductive film forming composition which is applied or printed on the resin substrate is dried. Thus, contact between fine patterns is avoided. As the thixotropic agent, although there is no limitation as long as the thixotropic agent is a thixotropic agent which is a known thixotropic agent (thixotropy imparting agent) used in the electrically conductive film forming composition including a solvent, and has no adverse influence on adhesiveness and conductivity of an electrically conductive film to be obtained, an organic thixotropic agent is preferable.

Examples of the thermoplastic resin (polymer binder) include acrylic resin, polyester resin, polyolefin resin, polyurethane resin, polyamide resin, rosin formulations, and vinyl polymers. These can be used alone or in combination of two or more thereof.

[Electrically Conductive Film Forming Composition]

The electrically conductive film forming composition includes copper oxide particles, copper particles, a specific organic compound, a solvent as required, and other components as required.

In the electrically conductive film forming composition, although not particularly limited, the mass ratio of the copper particles to the copper oxide particles (unit: % by mass) is preferably 50% by mass to 400% by mass, more preferably 80% by mass to 360% by mass, and still more preferably 100% by mass to 300% by mass. When the mass ratio is within the above range, the conductivity of an electrically conductive film to be obtained can be further improved.

The mass ratio of the copper particles to the copper oxide particles (unit: % by mass) is calculated by the following expression.

(W_{B}/W_{A})×100% by mass

Here, in the expression, W_{A} refers to the total mass of the copper oxide particles and W_{B} refers to the total mass of the copper particles.

In the electrically conductive film forming composition, although not particularly limited, the mass ratio of the specific organic compound to the copper oxide particles (unit: % by mass) is preferably 6% by mass to 60% by mass, more preferably 10% by mass to 50% by mass, and still more preferably 10% by mass to 30% by mass. When the mass ratio is within this range, the conductivity of an electrically conductive film to be obtained can be further improved.

The mass ratio of the specific organic compound to the copper oxide particles (unit: % by mass) is calculated by the following expression.

(W_{C}/W_{A})×100% by mass

Here, in the expression. W_{C} refers to the total mass of the specific organic compound and W_{A} refers to the total mass of copper oxide particles.

When the electrically conductive film forming composition includes a solvent, although not particularly limited, the content of the solvent is preferably 5% by mass to 90% by mass and more preferably 15% by mass to 70% by mass with respect to the total mass of the composition from the viewpoint of suppressing an increase in viscosity and obtaining further excellent handleability.

It is preferable that the viscosity of the electrically conductive film forming composition is adjusted to a viscosity suitable for printing such as ink jet and screen printing. In the case of performing an ink jet discharge operation, the viscosity is preferably 1 cP to 50 cP and more preferably 1 cP to 40 cP. In the case of performing screen printing, the viscosity is preferably 1,000 cP to 100,000 cP and more preferably 10,000 cP to 80,000 cP.

The method for preparing the electrically conductive film forming composition is not particularly limited and a known method can be adopted. For example, the composition can be obtained by adding the copper oxide particles, the copper particles, and the specific organic compound in the solvent, and then dispersing the components by known means such as an ultrasonic method (for example, a treatment using an ultrasonic homogenizer), a mixer method, a three-roll method, and a ball mill method. Alternatively, the copper oxide particles and the specific organic compound are mixed with the solvent and then the copper particles may be mixed with the liquid mixture (dispersion liquid).

[Method for Producing Electrically Conductive Film]

A method for producing an electrically conductive film of the present invention includes at least a coating film forming step and an electrically conductive film forming step. Each step will be described in detail below.

(Coating Film Forming Step)

The coating film forming step is a step of forming a coating film by applying the aforementioned electrically conductive film forming composition to the resin substrate.

As the resin substrate used in the step, a known resin substrate can he used. Examples of the resin substrate include a low density polyethylene resin substrate, a high density polyethylene resin substrate, an ABS resin substrate, an acrylic resin substrate, a styrene resin substrate, a vinyl chloride resin substrate, a polyester resin substrate (polyethylene terephthalate (PET) substrate), a polyacetal resin substrate, a polysulphone resin substrate, a polyether imide resin substrate (polyimide resin substrate), a polyether ketone resin substrate, a cellulose derivative substrate, a paper-phenol resin substrate (paper-phenol resin substrate), a paper-epoxy resin substrate (paper epoxy resin substrate), a paper-polyester resin substrate (paper polyester resin substrate), a glass fabric-epoxy resin substrate (glass epoxy resin substrate), a glass fabric-polyimide resin substrate (glass polyimide resin substrate), and a glass fabric-fluoro resin substrate (glass fluoro resin substrate). Among these, a polyethylene terephthalate (PET) substrate, a glass epoxy resin substrate, or a polyimide resin substrate is preferable, a glass epoxy resin substrate or a polyimide resin substrate is more preferable, and a polyimide resin substrate is particularly preferable.

Although not particularly limited, the thickness of the resin substrate is preferably within a range of 25 μm to 125 μm. When the thickness is 25 μm or more, warping does not easily occur and when the thickness is 125 μm or less, at the time of a heat treatment, heat is easily transferred to the coating film of the electrically conductive film forming composition.

The amount of the electrically conductive film forming composition applied to the resin substrate may be appropriately adjusted according to a desired thickness of an electrically conductive film and usually the thickness of the coating film is preferably 0.01 μm to 5,000 μm and more preferably 0.1 μm to 1,000 μm.

In the step, as required, the electrically conductive film forming composition may be applied to the resin substrate and then subjected to a drying treatment to remove the solvent. In the case of removing the remaining solvent, in the electrically conductive film forming step which will be described later, minute cracks or voids caused by vaporization expansion of the solvent can be prevented from occurring. Thus, this case is preferable from the viewpoint of the conductivity of the electrically conductive film and the adhesiveness between the electrically conductive film and the resin substrate.

The drying treatment can he performed by using a hot air dryer or the like and for the temperature, a temperature at which reduction of the copper oxide particles does not occur is preferable. The heat treatment is preferably performed at a temperature within a range of 40° C. to 200° C., the heat treatment is more preferably performed at a temperature within a range of 50° C. to lower than 150° C., and the heat treatment is still more preferably performed at a temperature within a range of 70° C. to 120° C.

(Electrically Conductive Film Forming Step)

The electrically conductive film forming step is a step of forming an electrically conductive film containing metal copper by performing a heat treatment for heating the formed coating film to a heating temperature of 140° C. to 400° C. at a temperature rising rate of 30° C./min to 10,000° C./min.

A decomposition material for generating a specific organic compound through decomposition by performing the heat treatment acts on the copper oxide as a reducing agent and the copper oxide is reduced and further sintered so as to obtain metal copper. More specifically, by the aforementioned treatment, the metal copper particles in the coating film are mutually fused to form grains and further the grains mutually adhere and are mutually fused to form a copper film.

The heat treatment is performed by heating the coating film to a heating temperature of 140° C. to 400° C. at a temperature rising rate of 30° C./min to 10,000° C./min.

In the case in which the temperature rising rate is lower than 30° C./min, before a reducing agent generated by decomposing the specific organic compound reaches the heating temperature, the reducing agent vaporizes and the copper oxide is not sufficiently reduced. Thus, conductivity and adhesiveness are deteriorated. In addition, in the case in which the temperature rising rate is higher than 10,000° C./min, volume shrinkage caused by reduction of the copper oxide rapidly occurs and thus the time for which stress is relaxed by the substrate is not given. As a result, the amount of warping in the resin substrate becomes too large.

The temperature rising rate is preferably within a range of 150° C./min to 4,000° C./min and more preferably within a range of 300° C./min to 1,500° C./min. When the temperature rising rate is within the range, comprehensive evaluation results in the evaluation items of “warping in resin substrate”, “adhesiveness, and “conductivity” are more satisfactory.

In the case in which the heating temperature is lower than 140° C., reduction of the copper oxide is not sufficient and conductivity and adhesiveness are deteriorated. In addition, in the case in which the heating temperature is higher than 400° C., the amount of warping in the resin substrate becomes too large.

The heating temperature is preferably 200° C. to 350° C. and more preferably 275° C. to 350° C. When the heating, temperature is within the range, comprehensive evaluation results in the evaluation items of “warping in resin substrate”, “adhesiveness, and “conductivity” are more satisfactory.

Although not particularly limited, the heating time is preferably 5 minutes to 120 minutes and more preferably 10 minutes to 60 minutes.

The heating means is not particularly limited and known heating means such as an oven and a hot plate can be used.

In the present invention, an electrically conductive film earl be formed by a heat treatment at a relatively low temperature and thus the present invention is advantageous in that process costs are low.

The atmosphere in which the heat treatment is performed is not particularly limited and the heat treatment may be performed under an air atmosphere, an inert atmosphere, or a reducing atmosphere. For example, the inert atmosphere refers to an atmosphere which is filled with an inert gas such as argon, helium, neon, and nitrogen, and the reducing atmosphere refers to an atmosphere in which a reducing gas such as hydrogen, carbon monoxide, formic acid, or alcohol is present.

(Electrically Conductive Film)

By performing the aforementioned step, an electrically conductive film (metal copper film) containing metal copper can be obtained.

The thickness of the electrically conductive film is not particularly limited and the thickness is adjusted to be optimal according to the purpose of use. In particular, when the electrically conductive film is used for a printed wiring substrate, the thickness is preferably 0.01 μm to 1,000 μm and more preferably 0.1 μm to 100 μm. The thickness is a value (an average value) obtained by measuring the thickness of the electrically conductive film at 3 or more arbitrary points and arithmetically averaging the values.

The volume resistivity of the electrically conductive film can be calculated by measuring the surface resistance value of the electrically conductive flint by a four-probe method, and then multiplying the surface resistance value by the film thickness. The volume resistivity is preferably less than 100 μΩ·cm, more preferably less than 50 μΩ·cm, and still more preferably less than 10 μΩ·cm.

The electrically conductive film may be provided over the entire surface of the resin substrate or in a pattern. The patterned electrically conductive film is useful as conductor wiring (wiring) of a printed wiring substrate or the like.

As a method for obtaining the patterned electrically conductive film, a method of applying the aforementioned electrically conductive film forming composition to the resin substrate in a pattern and performing a heat treatment, a method of etching the electrically conductive film provided on the entire surface of the resin substrate in a pattern, and the like can be used. The etching method is not particularly limited and known subtractive methods, semi-additive methods and the like can be adopted.

When the patterned electrically conductive film is used as a multilayer wiring substrate, an insulating layer (insulating resin layer, interlayer insulating film, solder resist) may be further laminated on the surface of the patterned electrically conductive film and wiring (metal pattern) may be further formed on the surface.

The material for the insulating film is not particularly limited and examples thereof include an epoxy resin, an aramid resin, a crystalline polyolefin resin, an amorphous polyolefin resin, a fluorine-containing resin (polytetrafluoroethylene, perfluorinated polyimide, perfluorinated amorphous resins, and the like), a polyimide resin, a polyether sulfone resin, a polyphenylene sulfide resin, a polyether ether ketone resin, a liquid crystal resin, and the like. Among these, from the viewpoint of adhesiveness, dimensional stability, heat resistance, electric insulation, and the like, a material which contains an epoxy resin, a polyimide resin, or a liquid crystal resin is preferable, and a material which contains an epoxy resin is more preferable. Specific examples of the insulating film include ABF GX-13 manufactured by Ajinomoto Fine-Techno Co., Inc., and the like.

In addition, a solder resist which is one of the materials for the insulating layer used for protecting wiring is described in detail, for example, in JP1998-204150A (JP-H10-204150A), JP2003-222993A, and the like and the materials described in the above can be applied to the present invention as required. Commercially available solder resists may be used, and specific examples thereof include PFR800 and PSR4000 (trade names) manufactured by TAIYO INK MFG. CO., LTD., SR7200G manufactured by Hitachi Chemical Co., Ltd., and the like.

The resin substrate (resin substrate with the electrically conductive film) having the electrically conductive film produced by the method for producing the electrically conductive film of the present invention can be used for various purposes. For example, the resin substrate can be used for a printed wiring substrate, TFT, FPC, RFID, and the like.

### EXAMPLES

### Example 1

### <Preparation of Electrically Conductive Film Forming Composition>

Copper oxide particles 1 (NanoTek, average particle diameter: 40 nm, manufactured by C. I. KASEI CO., LTD.) (100 parts by mass), glucose (30 parts by mass), water (ultrapure water) (40 parts by mass), and copper particles 1 (1200YP, average particle diameter: 3 μm, manufactured by MITSUI MINING & SMELTING CO., LTD.) (100 parts by mass) were added and the mixture was treated for 5 minutes using a revolving and rotating mixer (Awa-tori Rentaro ARE-310, manufactured by THINKY CORPORATION). Thus, an electrically conductive film forming composition was obtained.

### <Preparation of Electrically Conductive Film>

The obtained electrically conductive film forming composition was applied to a polyimide resin substrate (KAPTON 500H, manufactured by DU PONT-TORAY CO., LTD.) in a stripe shape (L/S=1 mm/1 mm) and then dried at 100° C. for 10 minutes. Thus, a coating film on which the electrically conductive film forming composition layer was pattern-printed was obtained. Thereafter, the coating film was heated to 300° C. using an RTA sintering apparatus (AccuThermo, manufactured by Allwin21 Corp.) at a temperature rising rate of 700° C./min, and the temperature was maintained for 10 minutes. Then, the film was cooled to 100° C. and a sample was taken out from the film. Thus, an electrically conductive film was obtained.

<Evaluation of Electrically Conductive Film>

(Warping)

In the obtained resin substrate with the electrically conductive film (hereinafter, referred to as a “sample” in the evaluation items), a distance between the surface plate and the side of the sample was measured according to the method described in 5.22 of JIS C 6481:1996 in 0.1 mm units. The evaluation criteria arc as follows. Here, Evaluation A or Evaluation B is practically preferable. The evaluation results are shown in relevant columns of Table 1.
A: A distance between the surface plate and the side of the sample is 0.5 mm or less.
B: A distance between the surface plate and the side of the sample is more than 0.5 mm and 1.0 mm or less.
C: A distance between the surface plate and the side of the sample is more than 1.0 mm and 2.0 mm or less.
D: A distance between the surface plate and the side of the sample is more than 2.0 mm and 5.0 mm or less.
E: A distance between the surface plate and the side of the sample is more than 5.0 mm.

(Adhesiveness)

A cellophane tape (width: 24 mm, manufactured by Nichiban Co., Ltd.) was attached to the obtained electrically conductive film and then was peeled off from the electrically conductive film. After the tape was peeled off, the appearance of the electrically conductive film was visually observed to evaluate adhesiveness. The evaluation criteria are as follows. Here, Evaluation A, Evaluation B, or Evaluation C is practically preferable. The evaluation results arc shown in relevant columns of Table 1.
A: The adhesion of the electrically conductive film to the tape is not observed and peeling-off at the interface between the electrically conductive film and the resin substrate is not observed.
B: The adhesion of the electrically conductive film to the tape is slightly observed but peeling-off at the interface between the electrically conductive film and the resin substrate is not observed.
C: The adhesion of the electrically conductive film to the tape is clearly observed but peeling-off at the interface between the electrically conductive film and the resin substrate is observed in an area of less than 5%.
D: The adhesion of the electrically conductive film to the tape is clearly observed and peeling-off at the interface between the electrically conductive film and the resin substrate is observed in an area of 5% or more and less than 50%.
E: The adhesion of the electrically conductive film to the tape is clearly observed and peeling-off at the interface between the electrically conductive film and the resin substrate is observed in an area of 50% or more.

(Conductivity)

The volume resistivity of the obtained electrically conductive film was measured by resistance measurement using a tour-probe method to measure conductivity. The evaluation criteria are as follows. Here, Evaluation A or Evaluation B is practically preferable. The evaluation results are shown in relevant columns of Table 1.
A: The volume resistivity is less than 10 μΩ·cm.
B: The volume resistivity is 10 μΩ·cm or more and less than 50 μΩ·cm.
C: The volume resistivity is 50 μΩ·cm or more and less than 100 μΩ·cm.
D: The volume resistivity is 100 μΩ·cm or more and less than 1,000 μΩ·cm.
E: The volume resistivity is 1,000 μΩ·cm or more.

### Examples 2 to 6

Electrically conductive films were obtained in the same manner as in Example 1 except that the temperature rising rate was changed to the values shown in Table 1, and the warping, adhesiveness, and conductivity were evaluated. The evaluation results are shown in relevant columns of Table 1.

### Examples 7 and 8

Electrically conductive films were obtained in the same manner as in Example 1 except that the heating temperature was changed to the values shown in Table 1, and the warping, adhesiveness, and conductivity were evaluated. The evaluation results are shown in relevant columns of Table 1.

### Example 9

An electrically conductive film was obtained in the same manner as in Example 1 except that the resin substrate was changed from the polyimide resin substrate to a polyethylene terephthalate (PET) substrate (written as “PET” in Table 1) and the heating temperature was changed from 300° C. to 140° C. according to the heat resistant temperature of PET, and the warping, adhesiveness, and conductivity were evaluated. The evaluation results are shown in relevant columns of Table 1.

### Example 10

An electrically conductive film was obtained in the same manner as in Example 1 except that the resin substrate was changed from the polyimide resin substrate to a glass epoxy resin substrate (written as “glass epoxy” in Table 1), and the warping, adhesiveness, and conductivity were evaluated. The evaluation results are shown in relevant columns of Table 1.

### Examples 11 and 12

Electrically conductive films were obtained in the same manner as in Example 1 except that the thickness of the polyimide resin substrate was changed from 125 μm to the values shown in Table 1, and the warping, adhesiveness and conductivity were evaluated. The evaluation results are shown in relevant columns of Table 1.

### Examples 13 to 15

Electrically conductive films were obtained in the same manner as in Example 1 except that the mass ratio of the copper particles 1 to the copper oxide particles 1 (unit: % by mass) was changed to the numerical values shown in Table 1, and the warping, adhesiveness, and conductivity were evaluated. The evaluation results are shown in relevant columns of Table 1.

### Examples 16 to 18

Electrically conductive films were obtained in the same manner as in Example 1 except that the mass ratio of the glucose to the copper oxide particles 1 (unit: % by mass) was changed to the numerical value shown in Table 1, and the warping, adhesiveness, and conductivity were evaluated. The evaluation results are shown in relevant columns of Table 1.

### Example 19

An electrically conductive film was obtained in the same manner as in Example 1 except that copper oxide particles 2 (average particle diameter: 80 nm, NO-0031-HP, manufactured by IoLiTec GmbH) were used instead of using copper oxide particles 1, and the warping, adhesiveness, and conductivity were evaluated. The evaluation results are shown in relevant columns of Table 1.

### Example 20

An electrically conductive film was obtained in the same manner as in Example 1 except that copper particles 2 (average particle diameter: 17 μm, MA-CJF, manufactured by MITSUI MINING & SMELTING CO., LTD.) were used instead of using copper particles 1, and the warping, adhesiveness, and conductivity were evaluated. The evaluation results are shown in relevant columns of Table 1.

### Examples 21 to 23

Electrically conductive films were obtained in the same manner as in Example 1 except that materials shown in Table 1 were used instead of using glucose, and the warping, adhesiveness, and conductivity re evaluated. The evaluation results are shown in relevant columns of Table 1.

### Examples 24 and 25

Electrically conductive films were obtained in the same manner as in Example 1 except that electrically conductive films were formed in a nitrogen atmosphere (Example 24) or in the air (Example 25) and the warping, adhesiveness, and conductivity were evaluated. The evaluation results are shown in relevant columns of Table 1.

### Comparative Examples 1 and 2

Electrically conductive films were obtained in the same manner as in Example 1 except that the temperature rising rate was changed to the values shown in Table 1, and the warping, adhesiveness, and conductivity were evaluated. The evaluation results are shown in relevant columns of Table 1.

### Comparative Examples 3 and 4

Electrically conductive films were obtained in the same manner as in Example 1 except that the heating temperature was changed to the values shown in Table 1, and the warping, adhesiveness, and conductivity were evaluated. The evaluation results are shown in relevant columns of Table 1.

### Comparative Example 5

An electrically conductive film was obtained in the same manner as in Example 1 except that polyvinylpyrrolidone (PVP, weight average molecular weight: 220,000) (30 parts by mass) was used instead of using glucose, and the warping, adhesiveness, and conductivity were evaluated. The evaluation results are shown in relevant columns of Table 1.

### Comparative Example 6

An electrically conductive film was obtained in the same manner as in Example 1 except that the electrically conductive film did not contain copper oxide particles, and the warping, adhesiveness, and conductivity were evaluated. The evaluation results are shown in relevant columns of Table 1.

### Comparative Example 7

An electrically conductive film was obtained in the same manner as in Example 1 except that the electrically conductive film did not contain copper particles, and the warping, adhesiveness, and conductivity were evaluated. The evaluation results are shown in relevant columns of Table 1.

TABLE 1
Table 1

| | | Copper | | | | | | | | | | | | | |
|---|---|---|---|---|---|---|---|---|---|---|---|---|---|---|---|
| | | oxide | | | Specific | | | | | | | | | | |
| | | parti- | Copper | | organic | | | | | | | | | | |
| | | cles | particles | | compound | | | | | Heat treatment | | | | | |
| | | Aver- | Aver- | | | 50% | | | | Tem- | | | | | |
| | | age | age | | | mass | | | | per- | Heat- | | | | |
| | | parti- | parti- | Mass | | reduc- | Mass | | | ature | ing | | | | |
| | | cle | cle | ratio*¹ | | tion | ratio*² | Resin substrate | | rising | tem- | | Evaluation | | |
| | | diam- | diam- | [% | | temper- | [% | | Thick- | rate | per- | | | Adhe- | Con- |
| | | eter | eter | by | | ature | by | | ness | [° C./ | ature | Atmo- | Warp- | sive- | duc- |
| | | [nm] | [μm] | mass] | Type | [° C.] | mass] | Type | [μm] | min] | [° C.] | sphere | ing | ness | tivity |
| Exam- | 1 | 40 | 3 | 100 | Glucose | 310 | 30 | Polyimide | 125 | 700 | 300 | Argon | A | A | A |
| ple | 2 | 40 | 3 | 100 | Glucose | 310 | 30 | Polyimide | 125 | 300 | 300 | Argon | A | A | A |
| | 3 | 40 | 3 | 100 | Glucose | 310 | 30 | Polyimide | 125 | 1,000 | 300 | Argon | A | A | A |
| | 4 | 40 | 3 | 100 | Glucose | 310 | 30 | Polyimide | 125 | 3,000 | 300 | Argon | B | A | A |
| | 5 | 40 | 3 | 100 | Glucose | 310 | 30 | Polyimide | 125 | 8,000 | 300 | Argon | B | A | B |
| | 6 | 40 | 3 | 100 | Glucose | 310 | 30 | Polyimide | 125 | 150 | 300 | Argon | A | A | B |
| | 7 | 40 | 3 | 100 | Glucose | 310 | 30 | Polyimide | 125 | 700 | 140 | Argon | A | B | B |
| | 8 | 40 | 3 | 100 | Glucose | 310 | 30 | Polyimide | 125 | 700 | 400 | Argon | B | A | A |
| | 9 | 40 | 3 | 100 | Glucose | 310 | 30 | PET*³ | 125 | 700 | 140 | Argon | A | B | A |
| | 10 | 40 | 3 | 100 | Glucose | 310 | 30 | Glass | 125 | 700 | 300 | Argon | A | A | A |
| | | | | | | | | epoxy*⁴ | | | | | | | |
| | 11 | 40 | 3 | 100 | Glucose | 310 | 30 | Polyimide | 25 | 700 | 300 | Argon | A | A | A |
| | 12 | 40 | 3 | 100 | Glucose | 310 | 30 | Polyimide | 10 | 700 | 300 | Argon | B | A | A |
| | 13 | 40 | 3 | 300 | Glucose | 310 | 30 | Polyimide | 125 | 700 | 300 | Argon | A | A | A |
| | 14 | 40 | 3 | 50 | Glucose | 310 | 30 | Polyimide | 125 | 700 | 300 | Argon | A | A | B |
| | 15 | 40 | 3 | 400 | Glucose | 310 | 30 | Polyimide | 125 | 700 | 300 | Argon | A | A | B |
| | 16 | 40 | 3 | 100 | Glucose | 310 | 10 | Polyimide | 125 | 700 | 300 | Argon | A | A | A |
| | 17 | 40 | 3 | 100 | Glucose | 310 | 6 | Polyimide | 125 | 700 | 300 | Argon | A | A | B |
| | 18 | 40 | 3 | 100 | Glucose | 310 | 60 | Polyimide | 125 | 700 | 300 | Argon | A | A | B |
| | 19 | 80 | 3 | 100 | Glucose | 310 | 30 | Polyimide | 125 | 700 | 300 | Argon | A | A | B |
| | 20 | 40 | 17 | 100 | Glucose | 310 | 30 | Polyimide | 125 | 700 | 300 | Argon | A | B | A |
| | 21 | 40 | 3 | 100 | Sorbitol | 350 | 30 | Polyimide | 125 | 700 | 300 | Argon | A | A | A |
| | 22 | 40 | 3 | 100 | Aminopropane | 180 | 30 | Polyimide | 125 | 700 | 300 | Argon | A | A | A |
| | | | | | diol | | | | | | | | | | |
| | 23 | 40 | 3 | 100 | Sucrose | 340 | 30 | Polyimide | 125 | 700 | 300 | Argon | A | A | A |
| | 24 | 40 | 3 | 100 | Glucose | 310 | 30 | Polyimide | 125 | 700 | 300 | Nitrogen | A | A | A |
| | 25 | 40 | 3 | 100 | Glucose | 310 | 30 | Polyimide | 125 | 700 | 300 | Air | A | B | B |
| Com- | 1 | 40 | 3 | 100 | Glucose | 310 | 30 | Polyimide | 125 | 10 | 300 | Argon | A | C | D |
| par- | 2 | 40 | 3 | 100 | Glucose | 310 | 30 | Polyimide | 125 | 12,000 | 300 | Argon | D | A | B |
| ative | 3 | 40 | 3 | 100 | Glucose | 310 | 30 | Polyimide | 125 | 700 | 120 | Argon | A | C | D |
| Exam- | 4 | 40 | 3 | 100 | Glucose | 310 | 30 | Polyimide | 125 | 700 | 500 | Argon | D | A | A |
| ple | 5 | 40 | 3 | 100 | PVP*⁵ | 430 | 30 | Polyimide | 125 | 700 | 300 | Argon | B | B | C |
| | 6 | — | 3 | 100 | Glucose | 310 | 30 | Polyimide | 125 | 700 | 300 | Argon | A | C | D |
| | 7 | 40 | — | 0 | Glucose | 310 | 30 | Polyimide | 125 | 700 | 300 | Argon | B | C | D |

In Table 1, *¹ to *⁵ are as follows.
*¹Mass ratio of copper particles to copper oxide particles
*²Mass ratio of specific organic compound to copper oxide particles
*³Polyethylene terephthalate
*⁴Glass epoxy resin substrate
*⁵Polyvinylpyrrolidone

(Description of Evaluation Results)

Examples 1 to 6 and Comparative Examples 1 and 2 are examples in which the temperature rising rate is focused on. In Examples 1 to 6 in which the temperature rising rate is within a range of 30° C./min to 10,000° C./min, the warping, adhesiveness, and conductivity were all satisfactory. In addition, in Examples 1 to 4 and 6 in which the temperature rising rate is within a range of 150° C./min to 4,000° C./min, two or more items among three items were evaluated as Evaluation A, and in Examples 1 to 3 in which the temperature rising rate is within a range of 300° C./min to 1,500° C./min, all items were evaluated as Evaluation A.

Examples 1, 7, and 8, and Comparative Examples 3 and 4 are examples in which the heating temperature is focused on. In Examples 1, 7, and 8 in which the heating temperature is within a range of 140° C. to 400° C., the warping, adhesiveness, and conductivity were all satisfactory. In Example 1 in which the heating temperature is within a range of 200° C. to 350° C., all items were evaluated as Evaluation A.

Examples 1, 9, and 10 are examples in which the type of the resin substrate is focused on. Since the heat resistance of PET is low, the heating temperature could not be set to be high and the adhesiveness was evaluated as Evaluation B. From the viewpoint of preventing warping and obtaining further excellent adhesiveness, a glass epoxy resin substrate or a polyimide resin substrate is preferable and a polyimide resin substrate is most preferable in consideration of flexibility of a resin substrate with an electrically conductive film to be obtained.

Examples 1, 11, and 12 are examples in which the thickness of the resin substrate is focused on. In Examples 1 and 11 in which the thickness is within a range of 25 μm to 125 μm, the warping was evaluated as Evaluation A and was excellent compared to Example 12 in which the thickness is 10 μm.

Examples 1, and 13 to 15 are examples in which the mass ratio of the copper particles to the copper oxide particles is focused on. Examples 1 and 13 in which the mass ratio is within a range of 100% by mass to 300% by mass exhibited excellent conductivity compared to Examples 14 and 15 in which the mass ratio is out of the range.

Examples 1, and 16 to 18 are examples in which the mass ratio of the specific organic compound to the copper oxide particles is focused on. Examples 1 and 16 in which the mass ratio is within, a range of 10% by mass to 50% by mass exhibited excellent conductivity compared. to Examples 17 and 18 in which the mass ratio is out of the range.

Examples 1 and 19 are examples in which the average particle diameter of the copper oxide particles is focused on. Example 1 in which the average particle diameter is within a range of 20 nm to 50 nm exhibited excellent conductivity compared to Example 19 in which the average particle diameter is out of the range.

Examples 1 and 20 are examples in which the average particle diameter of the copper particles is focused on. Example 1 in which the average particle diameter is within a range of 0.1 μm to 10 μm exhibited excellent conductivity compared to Example 20 in which the average particle diameter is out of the range.

Examples 1, and 21 to 23, and Comparative Example 5 are examples in which the type of the specific organic compound is focused on. In Examples 1, and 21 to 23 using an organic compound corresponding to the specific organic compound, all items were evaluated as Evaluation A and were excellent compared to Comparative Example 5 in which an organic compound corresponding to the specific organic compound was not used.

Examples 1, 24, and 25 are examples in which the atmosphere at the time of heat treatment is focused on. In Examples 1 and 24 in which the heat treatment is performed in an inert gas atmosphere, the adhesiveness and conductivity were excellent compared to Example 25 in which the heat treatment is performed in the air.

What is claimed is:

1. A method for producing an electrically conductive film comprising:
a coating film forming step of forming a coating film by applying an electrically conductive film forming composition including copper oxide particles, copper particles, and an organic compound having at least one functional group selected from the group consisting of a hydroxy group and an amino group and having a temperature at which a mass reduction rate when the film is heated at a temperature rising rate of 10° C./min is 50% within a range of 120° C. to 350° C., to a resin substrate; and
an electrically conductive film forming step of forming an electrically conductive film containing metal copper by performing a heat treatment for heating the coating film to a heating temperature of 140° C. to 400° C. at a temperature rising rate of 30° C./min to 10,000° C./min.

2. The method for producing an electrically conductive film according to claim 1,
wherein in the electrically conductive film forming step, the temperature rising rate is 150° C./min to 4,000° C./min.

3. The method for producing an electrically conductive film according to claim 1,
wherein in the electrically conductive film forming step, the temperature rising rate is 300° C./min to 1,500° C./min.

4. The method fur producing an electrically conductive film according to claim 1,
wherein in the electrically conductive film forming step, the heating temperature is 200° C. to 350° C.

5. The method for producing an electrically conductive film according to claim 1,
wherein the resin substrate is formed of polyimide.

6. The method for producing an electrically conductive film according to claim 1,
wherein the thickness of the resin substrate is 25 μm to 125 μm.

7. The method for producing an electrically conductive film according to claim 1,
wherein a mass ratio of the copper particles to the copper oxide particles is 100% by mass to 300% by mass.

8. The method for producing an electrically conductive film according to claim 1,
wherein a mass ratio of the organic compound to the copper oxide particles is 10% by mass to 50% by mass.

9. The method for producing an electrically conductive film according to claim 1,
wherein an average particle diameter of the copper oxide particles is 20 nm to 50 nm.

10. The method for producing an electrically conductive film according to claim 1,
wherein an average particle diameter of the copper particles is 0.1 μm to 10 μm.

11. The method for producing an electrically conductive film according to claim 1,
wherein in the electrically conductive film forming step, the heat treatment is performed in an inert gas atmosphere.

12. An electrically conductive film that is produced by the method for producing an electrically conductive film according to claim 1.

13. The method for producing an electrically conductive film according to claim 2,
wherein in the electrically conductive film forming step, the heating temperature is 200° C. to 350° C.

14. The method for producing an electrically conductive film according to claim 2,
wherein a mass ratio of the copper particles to the copper oxide particles is 100% by mass to 300% by mass.

15. The method for producing an electrically conductive film according to claim 2,
wherein an average particle diameter of the copper oxide particles is 20 nm to 50 nm.

16. The method for producing an electrically conductive film according to claim 2,
wherein an average particle diameter of the copper particles is 0.1 μm to 10 μm.

17. The method for producing an electrically conductive film according to claim 3,
wherein in the electrically conductive film forming step, the heating temperature is 200° C. to 350° C.

18. The method for producing an electrically conductive film according to claim 3,
wherein a mass ratio of the copper particles to the copper oxide particles is 100% by mass to 300% by mass.

19. The method for producing an electrically conductive film according to claim 3,
wherein an average particle diameter of the copper oxide particles is 20 nm to 50 nm.

20. The method for producing an electrically conductive film according to claim 3,
wherein an average particle diameter of the copper particles is 0.1 μm to 10 μm.
